(19) United States
(12) Patent Application Publication
(10) Pub. No.: US 2025/0306583 A1
(43) Pub. Date: Oct. 2, 2025

(54) PROCESS EQUIPMENT CRITICALITY ASSESSMENT AUTOMATION

(71) Applicant: SAUDI ARABIAN OIL COMPANY, Dhahran (SA)

(72) Inventors: Youssef Abbaoui, Dhahran (SA); Saad H. Moalwi, Dammam (SA); Abdulaziz E. Aldossary, Dammam (SA); Rabi M. Hakeem, Dammam (SA); Dahham M. Anazi, Dammam (SA)

(73) Assignee: SAUDI ARABIAN OIL COMPANY, Dhahran (SA)

(21) Appl. No.: 18/618,617

(22) Filed: Mar. 27, 2024

(51) Int. Cl. G05B 23/02

(52) U.S. Cl. CPC G05B 23/0283

(57) ABSTRACT

A method to perform an equipment maintenance operation of a facility. The method includes obtaining, from an Asset Management Solution (AMS) or a Computerized Maintenance Management System (CMMS), a hierarchical equipment list of the facility, identifying, from the hierarchical equipment list, functional locations each comprising pieces of equipment assigned respective equipment attributes in the AMS or CMMS, retrieving, from the AMS or CMMS, the equipment attributes of all equipment deployed in the functional locations, analyzing the equipment attributes to generate a failure consequences score, an importance score, a reliability and maintainability score, and a utilization score of each of the functional locations, and facilitating, based on the failure consequences score, the importance score, the reliability and maintainability score, and the utilization score of each of the functional locations, the equipment maintenance operation of the facility.

### BACKGROUND

Businesses generally use assets to deliver products or services. The dependence on these assets introduces risk for the businesses. Physical assets are referred to as equipment, which require expensive maintenance programs to offset the risk for the business operating the equipment. Criticality Analysis (CA) is a structured and systematic method of assessing the risk that equipment failures pose to a business. The CA method is used to rank the criticality of equipment relative to each other, which supports targeted equipment maintenance strategies prioritized according to the equipment failure's impact.

### SUMMARY

In general, in one aspect, the invention relates to a method to perform an equipment maintenance operation of a facility. The method includes obtaining, from an Asset Management Solution (AMS) or a Computerized Maintenance Management System (CMMS), a hierarchical equipment list of the facility, identifying, from the hierarchical equipment list, a plurality of functional locations of the facility, wherein each of the plurality of functional locations comprises a plurality of pieces of equipment, wherein each of the plurality of pieces of equipment is assigned a plurality of equipment attributes in the AMS or CMMS, retrieving, from the AMS or CMMS, the plurality of equipment attributes of all equipment deployed in the plurality of functional locations, analyzing the plurality of equipment attributes of all equipment deployed in the plurality of functional locations to generate a failure consequences score, an importance score, a reliability and maintainability score, and a utilization score of each of the plurality of functional locations, and facilitating, based on the failure consequences score, the importance score, the reliability and maintainability score, and the utilization score of each of the plurality of functional locations, the equipment maintenance operation of the facility.

In general, in one aspect, the invention relates to a Process Equipment Criticality Assessment (PECA) engine for an equipment maintenance operation of a facility. The PECA engine includes a computer processor, and memory storing instructions, when executed by the computer processor comprising functionality for obtaining, from an Asset Management Solution (AMS) or a Computerized Maintenance Management System (CMMS), a hierarchical equipment list of the facility, identifying, from the hierarchical equipment list, a plurality of functional locations of the facility, wherein each of the plurality of functional locations comprises a plurality of pieces of equipment, wherein each of the plurality of pieces of equipment is assigned a plurality of equipment attributes in the AMS or CMMS, retrieving, from the AMS or CMMS, the plurality of equipment attributes of all equipment deployed in the plurality of functional locations, analyzing the plurality of equipment attributes of all equipment deployed in the plurality of functional locations to generate a failure consequences score, an importance score, a reliability and maintainability score, and a utilization score of each of the plurality of functional locations, and facilitating, based on the failure consequences score, the importance score, the reliability and maintainability score, and the utilization score of each of the plurality of functional locations, the equipment maintenance operation of the facility.

In general, in one aspect, the invention relates to a facility that includes a plurality of functional locations, wherein each of the plurality of functional locations comprises a plurality of pieces of equipment, an Asset Management Solution (AMS) for managing an equipment performance and maintenance operation of the facility, a Computerized Maintenance Management System (CMMS) for performing an equipment maintenance operation of the facility, wherein each of the plurality of pieces of equipment is assigned a plurality of equipment attributes in the CMMS, and a Process Equipment Criticality Assessment (PECA) engine comprising functionality for obtaining, from the AMS or CMMS, a hierarchical equipment list of the facility, identifying, from the hierarchical equipment list, the plurality of functional locations, retrieving, from the AMS or CMMS, the plurality of equipment attributes of all equipment deployed in the plurality of functional locations, analyzing the plurality of equipment attributes of all equipment deployed in the plurality of functional locations to generate a failure consequences score, an importance score, a reliability and maintainability score, and a utilization score of each of the plurality of functional locations, and facilitating, based on the failure consequences score, the importance score, the reliability and maintainability score, and the utilization score of each of the plurality of functional locations, the equipment maintenance operation of the facility.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B show a system in accordance with one or more embodiments.

FIG. 2 shows a method flowchart in accordance with one or more embodiments.

FIGS. 3A-3G show an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments disclosed herein include a method and system for performing equipment maintenance of a business entity based on automated Process Equipment Criticality Assessment (PECA) using a structured multicriteria assessment algorithm in the business entity's Asset Management Solution (AMS). The AMS includes hardware/software that enables business entity to manage its equipment effectively and efficiently by harnessing the power of data and analytics, with the aim of maximizing asset performance, minimizing risks, and improving operational efficiency.

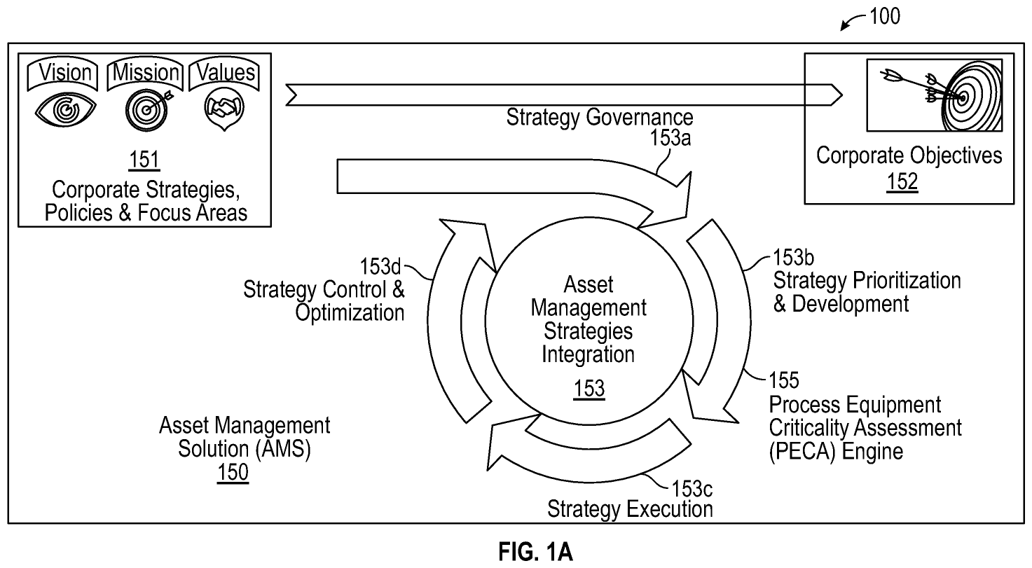

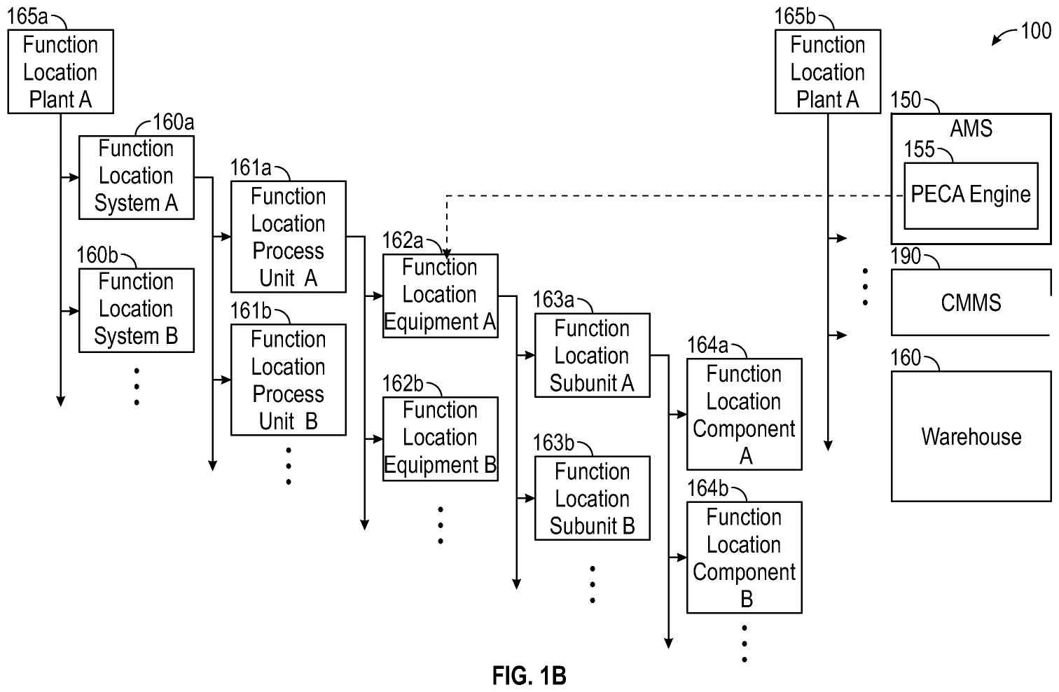

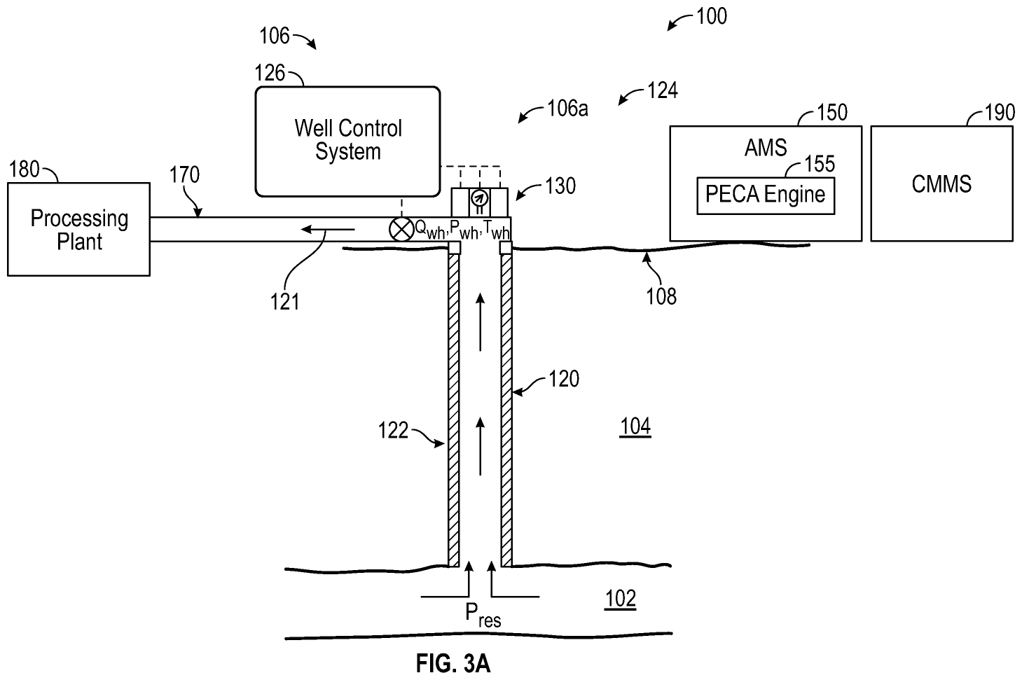

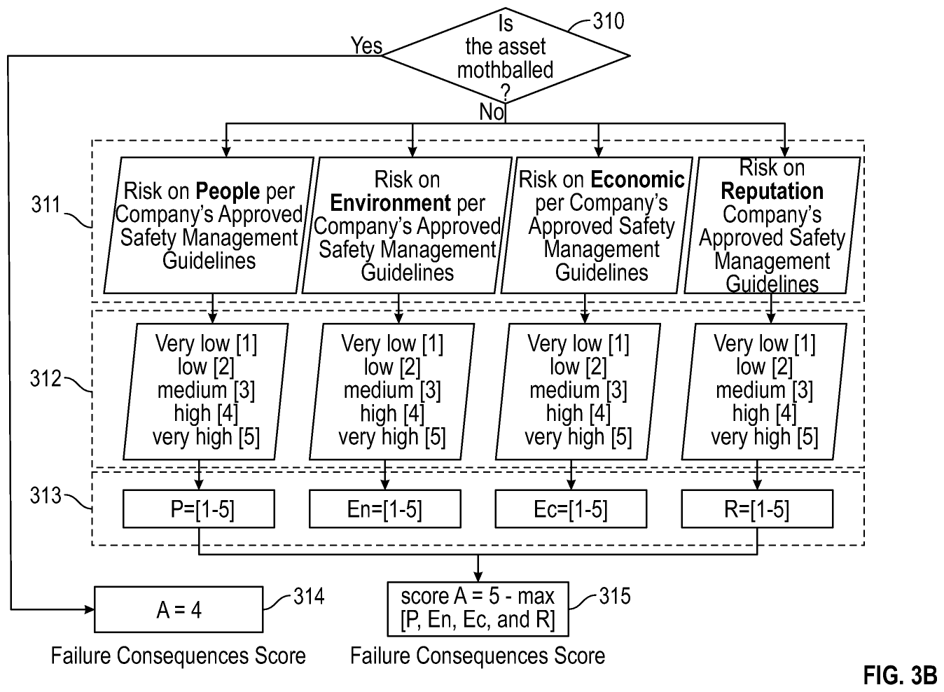

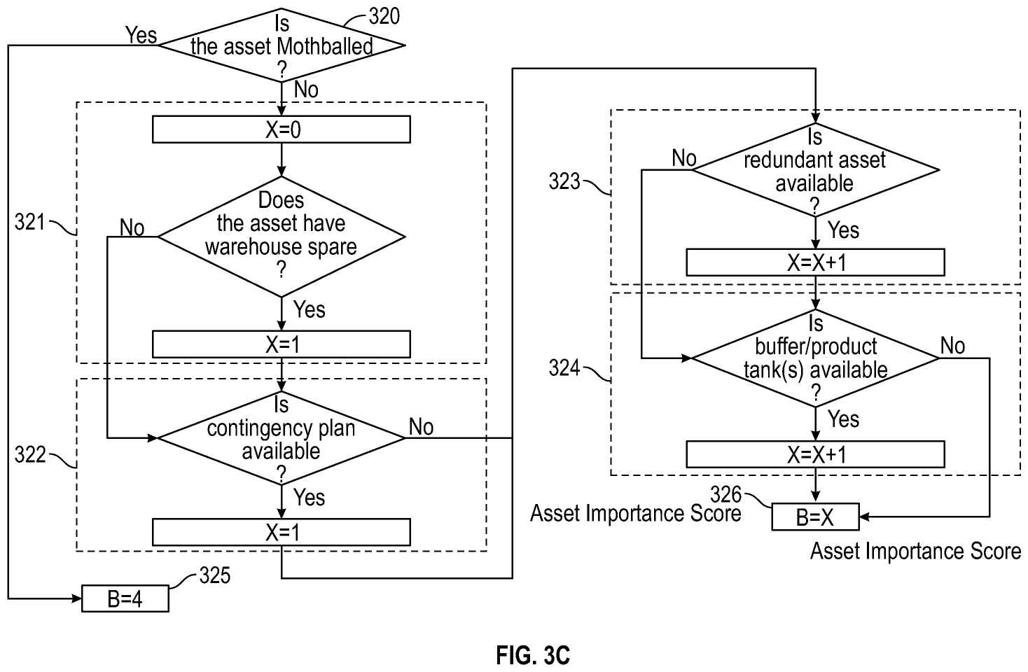

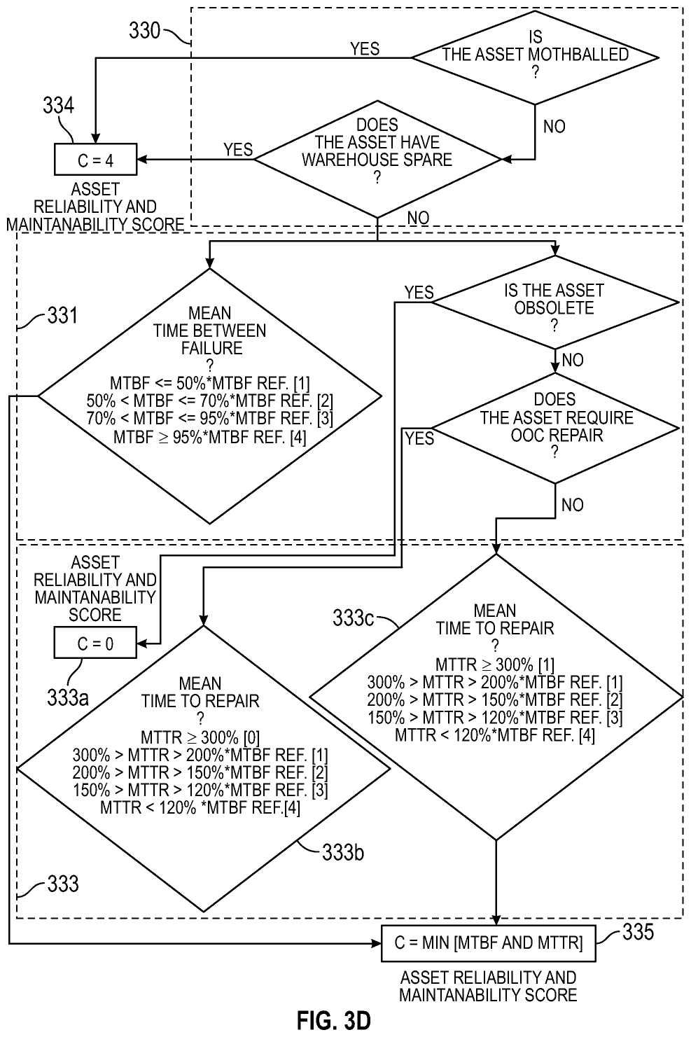

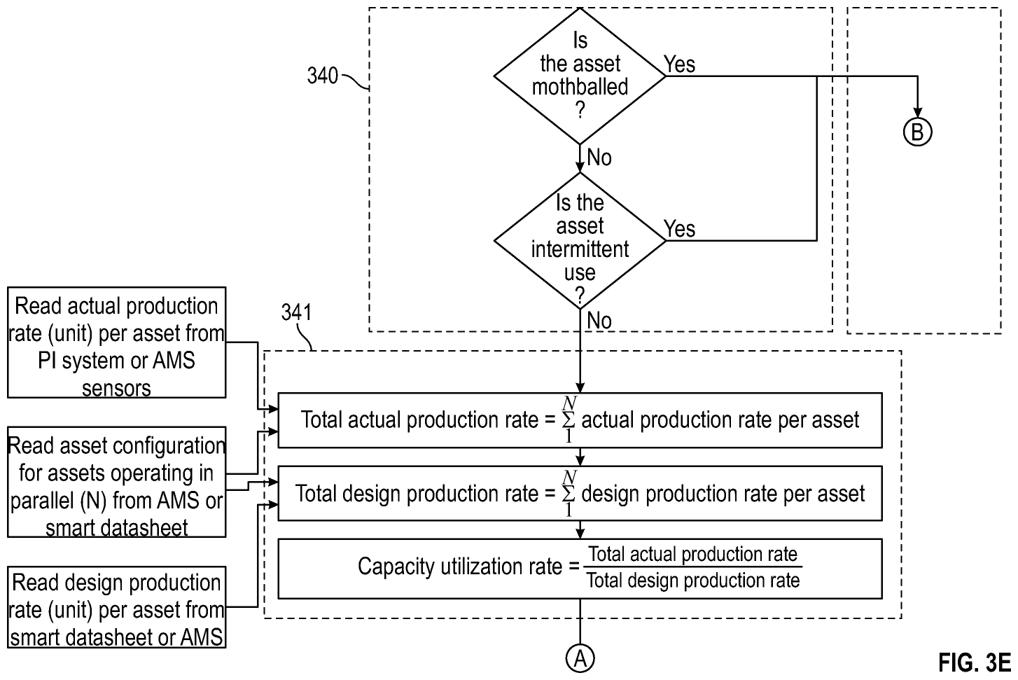

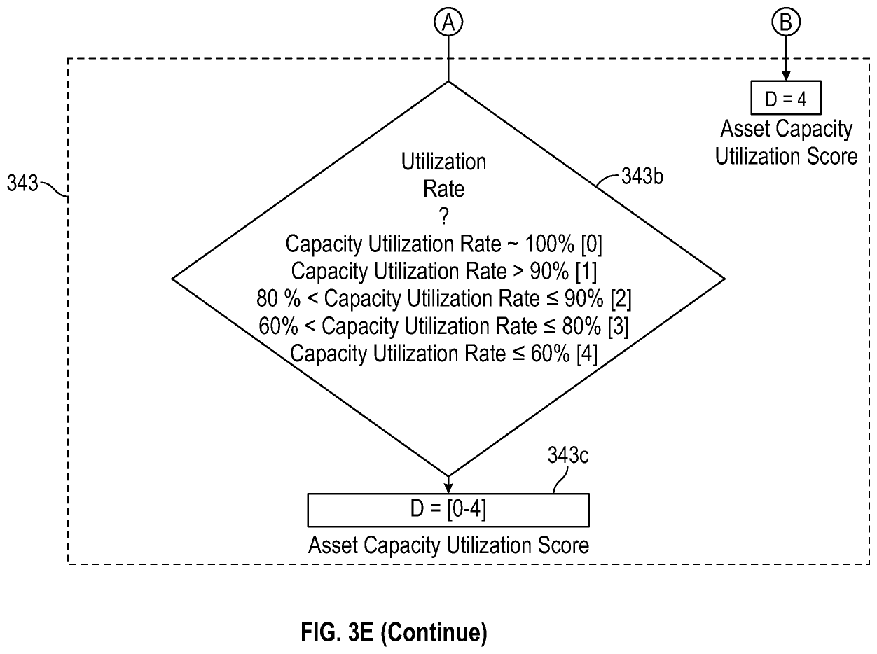

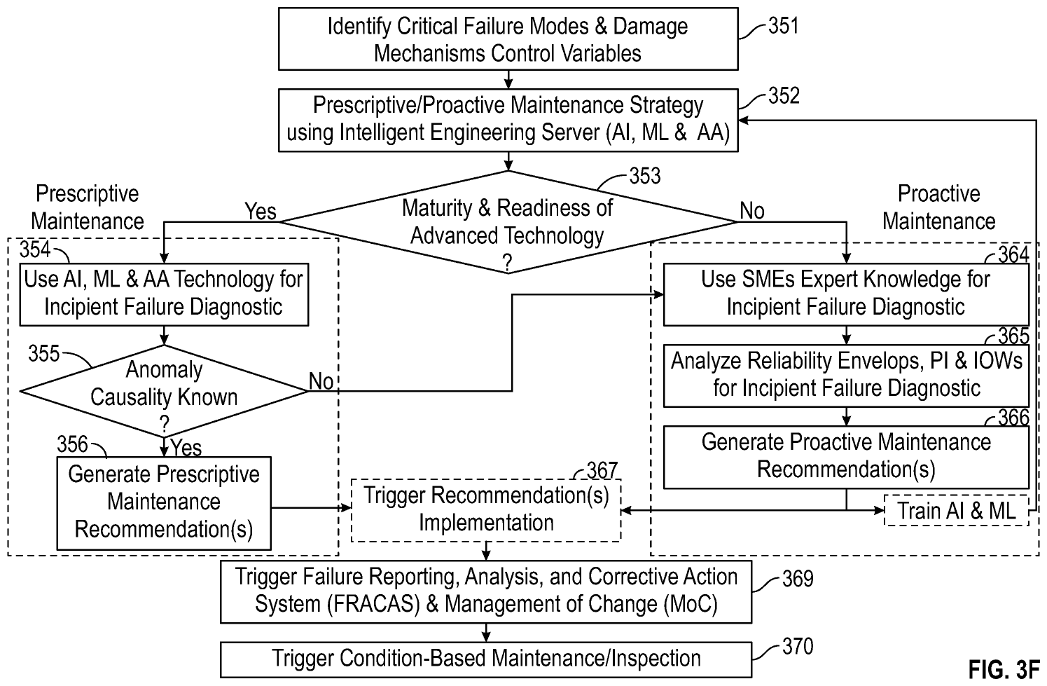

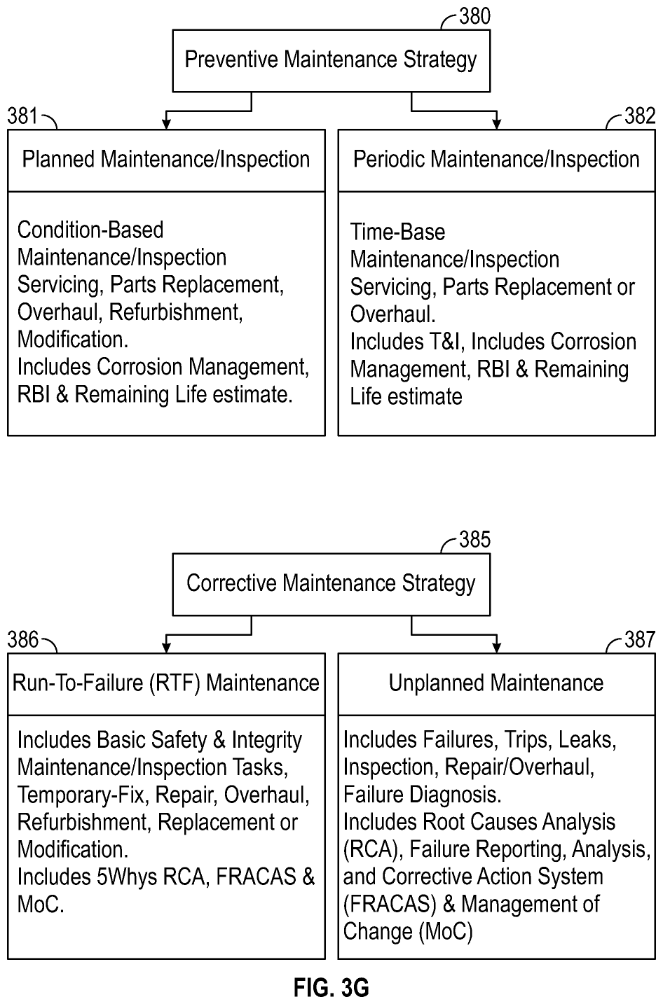

FIGS. 1A and 1B show a system in accordance with one or more embodiments. In particular, FIGS. 1A and 1B illustrate performing equipment maintenance based on automated PECA at the functional location level within a CMMS of the business entity. In one or more embodiments, one or more of the modules and/or elements shown in FIGS. 1A and 1B may be omitted, repeated, combined and/or substituted. Accordingly, embodiments disclosed herein should not be considered limited to the specific arrangements of modules and/or elements shown in FIGS. 3A-3E.

FIG. 1A shows a diagram that illustrates a business entity (100) that uses AMS (150) to implement asset management strategies integration (153), which is a systematic alignment between the asset management forming strategies including governance, development, execution and control (153a, 153b, 153c, 153d) and the business entity's governing strategies, policies and focus area (151). The AMS (150) provides a holistic view of assets throughout their entire lifecycle, enabling strategic decision-making and effective Asset Strategy Management (ASM).

As shown in FIG. 1A, the business entity's governing strategies (153a) is derived from the corporate strategies, policies and focus area (151) for achieving corporate objectives (152) of the business entity (100). The asset management strategies development and execution of the business entity (100) includes four forming strategies, i.e., strategy governance (153a), strategy prioritization and development (153b), strategy execution (153c), and strategy control and optimization (153d). In one or more embodiments, the asset management strategies integration (153) is facilitated in the AMS (150) using a PECA engine (155) to perform the automated PECA during the phase of strategy prioritization and development (153b). In particular, PECA automation is the cornerstone of the asset management strategies development and integration (153) to ensure that appropriate maintenance strategies are selected according to business priorities and governing strategies (153a), and consequently are being executed effectively in the field.

Inclusion of the automated PECA in the asset management strategies integration (153) provides automatic selection of appropriate maintenance strategies (i.e., Prescriptive/Proactive, Preventive and Corrective Maintenance Strategies) to be executed according to appropriate priority levels of the equipment (i.e., Production Critical, Production Important and Production Ordinary equipment). In one or more embodiments, the PECA engine (155) has the ability to automatically retrieve and analyze equipment attributes from the AMS (150) using a structured multicriteria assessment algorithm. This algorithm allows the PECA to determine priority levels for equipment maintenance. The equipment attributes that are considered include: (i) equipment failure consequences that encompasses factors such as the limitations and goals associated with the equipment's operation. It also considers the risk associated with equipment failure and the impact it would have on the overall operation; (ii) importance of equipment, which reflects the interdependence of different equipment within the local and global production system. It assesses how vital the equipment is to the overall functioning of the system; (iii) equipment reliability and maintainability, which characterizes the overall health conditions (i.e., reliability) and repair considerations (i.e., maintainability) of the equipment. It evaluates the equipment's ability to perform reliably and the ease of maintaining and repairing it; and finally (iv) equipment utilization that measures the extent to which the equipment is being used, either from a time perspective or a capacity perspective. It provides insights into the equipment's usage level. By considering these equipment attributes and employing the multicriteria assessment algorithm, the PECA can effectively determine the priority levels for equipment maintenance. In this context, the AMS (150) is referred to as an automatic evergreen asset strategy management system over the asset lifecycle of the equipment.

FIG. 1B shows a diagram that illustrates further details of performing automated PECA at different functional location levels, (including plant, system, process unit, equipment, subunit, and component) within the AMS (150) of the business entity (100). As shown in FIG. 1B, the equipment (e.g., equipment A (162a), equipment B (162b), etc.) deployed in a facility of the business entity (100) under the plant A (165a) in the production system A (160a) in the process unit A (161a) are managed in the AMS (150) according to respective plant functional locations (e.g., plant functional location A (165a), plant functional location B (165b), etc.). For example, the equipment A (162a), equipment B (162b), etc. are multiple pieces of equipment deployed in the process unit A (161a) in the production system A (160a) in the plant functional area A (165a) to collectively perform a particular function of the facility for the business entity (100). Although not explicitly shown, multiple pieces of other equipment are deployed in the plant functional area B (165b) to collectively perform a different function of the facility for the business entity (100). In particular, each of the equipment functional location A (162a) equipment functional location B (162b), etc. corresponds to a Process Flow Diagram (PFD) of the ERP software that models the particular function performed at the functional location. In one or more embodiments, the AMS (150) includes software, hardware, or a combination of software and hardware with the functionality to facilitate, or otherwise manage, the following maintenance tasks according to the results of the automated PECA, namely, (i) inspection, which establishes the actual condition of the systems or equipment; (ii) prescriptive/proactive maintenance which helps detect degradation at incipient stages and maintain ideal operating conditions; (iii) preventive maintenance, which helps to maintain design conditions for the system, process unit or equipment; and (iv) repair, for restoring the systems or equipment. For example, the AMS (150) may maintain an equipment record, determine maintenance priority, initiate one or more of the maintenance tasks, etc. The AMS (150) may perform these management functions in response to a user command, triggered by a pre-determined event, or periodically according to a pre-determined schedule.

In one or more embodiments, the business entity's assets are modeled or otherwise represented in the AMS (150) using a logically-organized structure that captures equipment specific engineering specifications and characteristic data. The logically-organized structure is a model that supports data flow from engineering design to procurement, installation, operation, and maintenance. For example, this model may conform to industry standard ISO 14224 for industrial automation systems and integration, such as integration of life-cycle data for process plants including oil and gas production facilities.

In one or more embodiments, the AMS (150) corresponds to the set of information technology (IT) solutions, work processes, and enablers required to successfully implement Asset Management practices using the disciplined approach of the Asset Management framework. The objective of this solution is to enable the business entity (100) to maximize the value of and from its assets and achieve its strategic objectives by effectively and efficiently managing them through their entire lifecycle. This encompasses activities such as optimal design, procurement, construction, commissioning, operation, decommissioning and disposal. In conjunction with the AMS (150) and consistent with the asset management strategies integration (153), the business entity (100) also uses a computerized maintenance management system (CMMS) (190) that includes hardware/software that optimizes maintenance activities and resources. For example, the CMMS (190) may provide a dashboard with KPIs that primarily focus on enhancing equipment reliability and minimizing downtime.

In one or more embodiments, the Asset Management Strategies are executed through the CMMS (190). Within the context of the AMS (150) and CMMS (190), a piece of equipment is an individual, identifiable (e.g., assigned a serial number or asset tag) physical device, whereas a functional location can be a physical object or a geographical or process location where physical devices are installed and maintenance tasks are to be performed. In particular, the functional location provides a layer in the model to organize the physical pieces of equipment. In one or more embodiments, the functional location is created according to a hierarchy, such as the plant related function location A (165a), production system related function location A (160a), process unit related function location A (161a), equipment related function location A (162a), subunit related function location A (163a), and component related function location A (164a) that are managed in the AMS (150) according to respective plant related functional locations (e.g., plant related functional location A (165a), plant related functional location B (165b), etc.). In other words, the functional location is a data organizational unit within the AMS (150) and CMMS (190) software to represent a physical location in a physical plant or facility. More specifically, the functional location structures the asset management and maintenance objects of the business entity according to functional, process or spatial criteria. In one or more embodiments where the functional location is based on a process, the equipment at the functional location (i.e., equipment deployed at the corresponding physical plant location) executes the respective process requirements as defined in a Process Flow Diagram (PFD) of the AMS software. The PFD corresponds to a process performed in an operating facility of the business entity and PECA is executed at the equipment level of functional hierarchy of the plant (i.e., equipment related functional location A (162a)).

As an example shown in FIG. 1B, the business entity (100) may operate a plant such as a natural gas liquids (NGL) plant having multiple fractionation systems (160a, 160b) that has fractionator trains corresponding to the process unit related functional locations (161a, 161b). In particular, the functional location A (165a) corresponds to a fractionator train where the equipment related function location A (162a) corresponds to a turbine and the equipment related function location B (162b) corresponds to a condenser. The turbine, condenser, and other related equipment deployed at the functional location A (165a) collectively perform the fractionation process of the NGL plant. Further, the equipment A (162a) includes multiple subunits (163a, 163b) where the equipment subunit A (163a) corresponds to a gas generator having multiple components (164a, 164b) that are maintainable, such as the maintainable component A (164a) being a thrust-bearing. In the hierarchy shown in FIG. 1B, the equipment functional location A (162a) is defined in a PFD of the AMS (150) and CMMS (190) that describes the NGL fractionating process performed by the fractionator train.

In one or more embodiments, the PECA engine (155) includes software, hardware, or a combination of software and hardware with the functionality to automatically allocate equipment criticality with respect to the functional location, i.e., at the equipment functional location level (162a) in FIG. 1B. Although the PECA engine (155) is shown in FIG. 1B as within the AMS (150), the PECA engine (155) may also reside within the CMMS (190) in other embodiments. In one or more embodiments, the PECA engine (155) automatically retrieves an equipment list, e.g., referred to as the ‘Asset Register’ of the AMS (150), and allocates the equipment criticality at the fourth Level of Asset Functional Location (i.e., Core Business Structural Indicator) Hierarchy. For example, the fourth level may correspond to the PFD specified equipment ID at the equipment related function area A (162a). The PECA engine (155) uses algorithms that specifies the sources of equipment attributes input data, and defines the weighting and scoring of criticality criteria for calculating the criticality index and establishing thresholds for classifying assets based on their production criticality. Examples of the algorithms of the PECA engine (155) are described in reference to FIGS. 3B-3E below. This automation process is embedded in AMS modules and executes automatically with no human intervention to eliminate the human subjectivity when conducting PECA. While the PECA may be initiated in response to a user command, triggered by a pre-determined event, or performed periodically according to a pre-determined schedule, once initiated the PECA engine (155) performs the PECA to determine equipment maintenance priority without any further human intervention.

In one or more embodiments, the business entity (100) includes a warehouse (160) to store necessary parts and materials for performing maintenance tasks of the equipment such as a piece of spare equipment, spare sub-equipment and/or spare components of the equipment or sub-equipment. The spare equipment is a piece of equipment that has equivalent functionality as the equipment in use and can be deployed to substitute the equipment in use when equipment failure occurs. Similarly, the spare sub-equipment is a piece of sub-equipment that has equivalent functionality as the sub-equipment in use and can be deployed to substitute the sub-equipment in use when sub-equipment failure occurs. The transactions of maintenance materials are recorded by the CMMS (190) and takes into account for the priority determined by the PECA engine (155).

Automating the Process of Equipment Criticality Assessment enables the business entity (100) to streamline the assets classification based on their criticality on the business entity (100) production system and reduce the human-beings subjectivity. The systematic automation of PECA in AMS ensures a systematic alignment between the asset management strategies development and execution and governing strategies of the business entity (100).

Current AMS and CMMS software do offer the criticality indicator at component level only, thus cannot be used for asset management strategy prioritization & development. Asset management strategy prioritization & development (153b) involves identifying, evaluating, and creating a strategic plan to manage the assets of a business entity (100) effectively and efficiently. This includes allocating resources optimally based on each asset's impact on production, importance to operations, and reliability conditions, with the aim of maximizing value for Business entity 100. Asset management strategy prioritization is done by ranking assets according to their criticality and risk to operations, as well as their impact on health, safety, environment (HSE), and the reputation of the business entity. This enables the allocation of limited resources to focus on the most significant assets. Asset management strategy development encompasses the creation of a comprehensive strategy that outlines objectives, policies, and procedures for acquiring, operating, maintaining, replacing, and disposing of assets throughout their lifecycle. The ultimate goal of asset management strategy prioritization & development (153b) is to maximize the assets value, minimize operating costs, mitigate and manage risks at acceptable levels, and align asset management efforts with the overall goals and objectives of business entity (100). Through this process, the assets of the business entity (100) may be categorized into three distinct groups of assets including ‘Production Critical’, ‘Production Important’ and ‘Production Ordinary’ assets. This classification allows for a clear understanding of the assets' significance in relation to production, enabling appropriate prioritization and resources allocation for effective asset management. Opposite the equipment criticality provided by the AMS and CMMS software, PECA (155) is conducted at the function location equipment level (e.g., equipment related function area A (162a)) rather than the function location component level (e.g., component related function area A (164a)) for several reasons. Assessing criticality at the equipment level allows for a more comprehensive and holistic understanding of the overall impact on the operations of the plant related function location A (165a). Equipment related function location A (162a) is often composed of multiple subunit related function locations (163a, 163b) and component related function locations (164a, 164b) that work together to perform the needed function at the process unit related function location level, such as the process unit related function location A (161a) in the system related function location A (160a) under the plant related function location A (165a). By evaluating criticality at the equipment related function location level, the assessment takes into account the dependencies and interactions between various subunits and components, providing a more accurate assessment of the equipment's criticality in relation to the entire business entity (100) including its plants, production systems process units and different equipment. Furthermore, performing PECA at the hierarchy level of equipment related function locations (162a, 162b) offers the advantage of expediting the analysis process compared to conducting it at the level of component related function locations (1164a, 64b). For example, analyzing PECA at equipment related function location level takes approximately 2-3 months for a large complex refinery, while analyzing PECA at component related function location level would typically require 16-24 months due to the significantly larger number of components involved. By conducting PECA at the equipment related function location level, a more comprehensive understanding of the equipment's impact on the operations of the business entity (100) can be achieved in a much shorter time. This, in turn, allows for efficient allocation of resources and enables the implementation of targeted risk mitigation strategies, ensuring the smooth functioning of various plants (165a, 165b, etc.) within the business entity (100). To properly use equipment criticality to prioritize and develop asset management strategy, there is a need to conduct PECA at equipment related function location level and not component related function location level. The ultimate goal of asset management strategy prioritization & development (153b) is to maximize the assets value, minimize operating costs, mitigate and manage risks at acceptable levels, and align asset management efforts with the overall goals and objectives of the business entity (100) by deploying the right maintenance strategies according to the production criticality of the assets as identified by PECA engine (155) at the equipment related function location level.

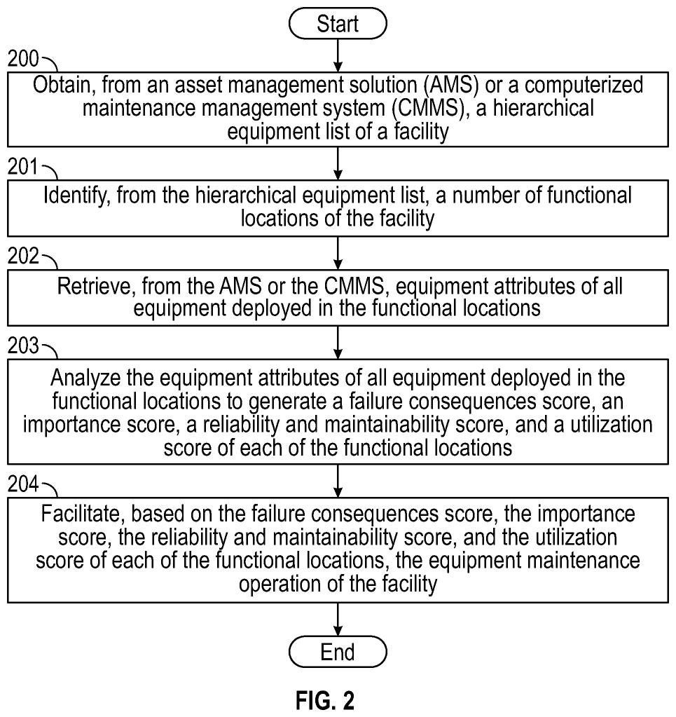

Turning to FIG. 2, FIG. 2 shows a process flowchart in accordance with one or more embodiments. FIG. 2 may be performed using one or more components as described in FIGS. 1A-1B. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

In one or more embodiments, the process flowchart corresponds to a method to perform an equipment maintenance operation of a facility. The process flowchart is based on an algorithm with pre-defined questions and answers through systematic methodology to minimize the human subjectivity. The pre-defined questions and answers correspond to part of the equipment attributes that are automatically retrieved from the AMS (150) and analyzed by the PECA (155) as described above. This automation process is embedded in the AMS or CMMS and executes automatically with minimal human intervention to ensure that PECA is conducted at the equipment related functional location level (i.e., PFD level) instead of at component related functional level. This automation process increases consistency of PECA execution across the board throughout the business entity to achieve a systematic alignment between the asset management strategies development and execution and the governing strategies of the business entity.

Initially in Step 200, a hierarchical equipment list of a facility is obtained from an Asset Management Solution (AMS) or a Computerized Maintenance Management System (CMMS).

In Step 201, a number of functional locations of the facility is identified from the hierarchical equipment list. Each of the equipment related functional locations is deployed a number of pieces of equipment, where each piece of equipment is assigned a set of equipment attributes in the AMS or CMMS.

In Step 202, the set of equipment attributes of all equipment deployed in the equipment related functional locations are retrieved from the AMS or CMMS.

In Step 203, the equipment attributes of all equipment deployed in the equipment related functional locations are analyzed to generate a failure consequences score, an importance score, a reliability and maintainability score, and a utilization score of each of the functional locations.

In one or more embodiments, the failure consequences score is generated by (i) determining, based on the equipment attributes, a measure of human risk, a measure of environmental risk, a measure of economic risk, and a measure of reputation risk that correspond to an equipment failure event at each of the equipment related functional locations, and (ii) aggregating, using a pre-determined algorithm, the measure of human risk, the measure of environmental risk, the measure of economic risk, and the measure of reputation risk to calculate the failure consequences score of the equipment related functional locations.

In one or more embodiments, the importance score is generated by (i) determining, based on the equipment attributes, a measure of warehouse spare availability, a measure of contingency plan availability, a measure of redundant equipment availability, and a measure of equipment output buffer availability that correspond to an equipment failure event at each of the equipment related functional locations, and (ii) aggregating, using a pre-determined algorithm, the measure of warehouse spare availability, the measure of contingency plan availability, the measure of redundant equipment availability, and the measure of equipment output buffer availability to calculate the importance score of each of the equipment related functional locations. In particular, the measure of contingency plan availability corresponds to spare parts for the equipment subunits and/or components. In contrast, the measure of redundant equipment availability corresponds to redundant equipment with same functionality, either of the same or different size or capacity, directly installed in the plant facility or stored in the warehouse.

In one or more embodiments, the reliability and maintainability score is generated by (i) determining, based on the equipment attributes, a measure of mean-time-between-failure and a measure of mean-time-to-repair that correspond to an equipment failure event at each of the equipment related functional locations, and (ii) aggregating, using a pre-determined algorithm, the measure of mean-time-between-failure and the measure of mean-time-to-repair to calculate the reliability and maintainability score of each of the equipment related functional locations.

In one or more embodiments, the utilization score is generated by (i) determining, based on the equipment attributes, a measure of equipment capacity and a measure of equipment utilization that correspond to said each of the equipment related functional locations, and (ii) aggregating, using a pre-determined algorithm, the measure of equipment capacity and the measure of equipment utilization to calculate the utilization score of each of the equipment related functional locations.

In Step 204, the equipment maintenance operation is facilitated based on the failure consequences score, the importance score, the reliability and maintainability score, and the utilization score of each of the equipment related functional locations.

In one or more embodiments, a criticality index of each of the functional locations is calculated based on the failure consequences score, the importance score, the reliability and maintainability score, and the utilization score of each of the equipment related functional locations. Accordingly, a production priority and hence maintenance priority ranking of the equipment related functional locations is generated based on respective criticality indices, and the equipment maintenance operation of the facility is performed according to the maintenance priority ranking.

In one or more embodiments, each of the equipment related functional locations is categorized based on the criticality index into one of a production critical category, a production important category, and a production ordinary category. Accordingly, the equipment maintenance operation is performed as a prescriptive/proactive maintenance operation for the production critical category, a preventive maintenance operation for the production important category, and a corrective maintenance operation for the production ordinary category.

Prescriptive maintenance is a maintenance strategy that uses advanced analytics, artificial intelligence (AI) and machine learning (ML) technologies and AI algorithms (AA) to collect and analyze data about the condition of an equipment, and automatically make specific recommendations to reduce operational risks. Proactive maintenance refers to a systematic approach that prevents failures at incipient stage through analysis of operational and design parameters and maximizes the reliability and productivity of assets. Proactive maintenance involves taking preemptive measures to identify and address potential issues before they result in breakdowns or downtime to reduce operational risks. Preventive maintenance involves scheduled maintenance activities, either condition-based or time-based, that prevent equipment failures and reducing the chances of breakdowns or downtime. Corrective maintenance involves reactive repair or restoration of equipment or systems following a failure or malfunction. It encompasses both run-to-failure (RTF) and unplanned maintenance activities, that restores equipment to normal operational condition.

FIGS. 3A-3G show an example in accordance with one or more embodiments. The example shown in FIGS. 3A-3G is based on the system and method described in reference to FIGS. 1A, 1B, and 2 above. In one or more embodiments, one or more of the modules and/or elements shown in FIGS. 3A-3G may be omitted, repeated, combined and/or substituted. Accordingly, embodiments disclosed herein should not be considered limited to the specific arrangements of modules and/or elements shown in FIGS. 3A-3G.

FIG. 3A shows a schematic diagram of an oil and gas facility in accordance with one or more embodiments. As shown in FIG. 3A, an oil and gas facility operated by the business entity (100) that includes a hydrocarbon reservoir (“reservoir”) (102) located in a subsurface hydrocarbon-bearing formation (“formation”) (104), a well system (106), and a processing plant (180) are illustrated. In one or more embodiments, the processing plant (180) includes gas/oil separation plant (GOSP), gas processing plant, refinery, and NGL plants. The area where the well system (106) is located is referred to as a wellsite (106a). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). The well system (106) may be part of a production system that further includes a pipeline network (170) and a gas/oil separation plant (180) for transporting and processing the hydrocarbons, i.e., production from the reservoir (102).

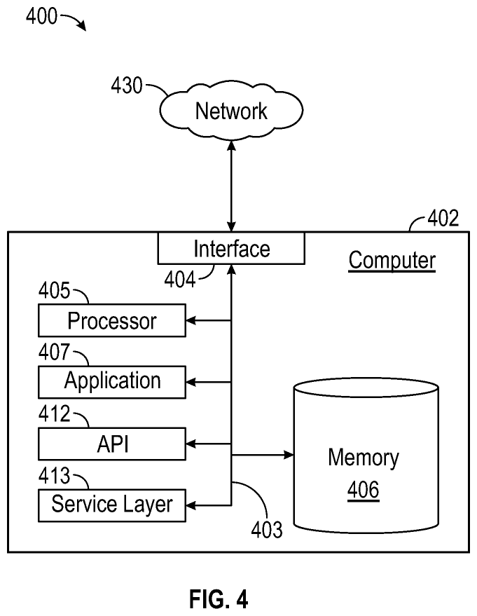

In some embodiments, the well system (106) includes a wellbore (120), a well sub-surface system (122), a well surface system (124), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system that is similar to the computing system (400) described below with regard to FIG. 4 and the accompanying description.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein.

In some embodiments, the well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing.

In some embodiments, during operation of the well system (106), the control system (126) collects and records well system data using sensor devices of the well system (106). The well system data may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well system (106), and water cut data.

In one or more embodiments, the gas oil separation plant (180) is directed to an industrial process plant such as an oil/petroleum refinery or NGL plant where petroleum (crude oil) is transformed and refined, or other types of chemical processing plants. The gas/oil separation plant (180) and the downstream industrial process plants typically include large, sprawling industrial complexes with extensive piping network running throughout, carrying streams or liquids between large chemical processing units, such as high and low pressure separation traps, dehydrators, low and high pressure gas compressors, water oil serration plant, shipping and booster pumps, desalters, distillation columns, naphtha hydrotreating, etc. Processing plant facilities require frequent inspection in order to ensure the asset integrity of the structure and safe work practices.

As described above, the equipment of the oil and gas facility operated by the business entity (100) includes tubing, pipeline, control valve, pump, motor, sensor device, etc. that are managed using the AMS (150) or CMMS (190) based on production and maintenance priorities at the functional location level as determined by the PECA engine (155). For example, the functional locations may correspond to different equipment at functional location levels in the well surface system (124), the well sub-surface system (122), the gas/oil separation plant (180), etc.

Although the PECA engine (155) is shown in FIG. 3A as within the AMS (150), the PECA engine (155) may also reside within the CMMS (190) in other embodiments. While the AMS (150) or CMMS (190) and PECA engine (155) are shown at a well site and processing plant, embodiments are contemplated where at least a portion of the AMS (150) or CMMS (190) and PECA engine (155) is located away from well sites or processing plants. In some embodiments, the AMS (150) or CMMS (190) and PECA engine (155) may include a computer system that is similar to the computing system (400) described below with regard to FIG. 4 and the accompanying description.

FIGS. 3B-3E show example algorithms used by the PECA engine (155) to determine production and maintenance priorities at the functional location level. Specifically, the algorithms calculate a failure consequences score, an importance score, a reliability and maintainability score, and a utilization score of an asset where the value of each score ranges from zero (0), indicating high criticality to four (4), indicating low criticality of the asset. Throughout FIGS. 3B-3E, the term “asset” refers to equipment at a functional location level, and the term “mothballed” refers to the equipment kept in good condition without being used but can readily be used again.

Turning to FIG. 3B, FIG. 3B illustrates an algorithm for determining the asset failure consequences score of a functional location. In Block 310, it is determined whether the asset is mothballed. If the determination is positive, i.e., the asset is mothballed, the algorithm proceeds to Block 314 to assign the failure consequences score (denoted as A) of the asset with a value 4. If the determination is negative, i.e., the asset is not mothballed (i.e., in active use), the algorithm proceeds to Block 311 to evaluate the risk of the asset failure in a number of categories, e.g., the risk on people (e.g., safety of equipment operator), risk on environment (e.g., hazardous material), risk on economics (e.g., loss of production), and risk on reputation (e.g., customer delivery delay or cancellation). In Block 312, the risk evaluation results in five risk levels (i.e., very low, low, medium, high, and very high) according to a pre-determined guideline, e.g., referred to as the business entity (100) approved safety management guidelines (SMG). In Block 313, the risk on people, risk on environment, risk on economics, and risk on reputation are denoted as P, En, Ec, and R, respectively and assigned respective numerical values 1-5 for the risk level as outlined by Block 312. In particular, a higher numerical value corresponds to a higher risk level. Within Block 315, the failure consequences score of the asset will be assigned a value ranging from 1 to 5 for P, En, Ec, and R, in accordance with the safety management guidelines stated in Blocks 311 and 312. In Block 315, the maximum value of P, En, Ec, or R shall be subtracted from 5 to turn the failure consequences risk score as per PECA scoring guidelines from 0 to 4, where a score of 0 indicates the highest failure severity, while a score of 4 represents the lowest failure severity.

Turning to FIG. 3C, FIG. 3C illustrates an algorithm for determining the asset importance score (denoted as B) of a functional location. In Block 320, it is determined whether the asset is mothballed. If the determination is positive, i.e., the asset is mothballed, the algorithm proceeds to Block 325 to assign the asset importance score (denoted as B) of the asset with a value 4. If the determination is negative, i.e., the asset is not mothballed (i.e., in active use), the algorithm proceeds to evaluate an importance variable X in a sequential process. In Block 321, the importance variable X is initialized to 0 before it is determined whether the asset has a spare (i.e., a component or an equipment for repair or replacement) in the warehouse. If the determination is positive, i.e., the asset has a spare in the warehouse, the algorithm increments the importance variable X before proceeding to Block 322. If the determination is negative, i.e., the asset has not a spare in the warehouse, the algorithm proceeds directly to Block 322 without incrementing the importance variable X.

In Block 322, it is determined whether a contingency plan for the asset is available. The contingency plan is a set of procedures, e.g., to perform remedial tasks when the asset fails. If the determination is positive, i.e., a contingency plan for the asset is available, the algorithm increments the importance variable X before proceeding to Block 323. If the determination is negative, i.e., no contingency plan for the asset is available, the algorithm proceeds directly to Block 323 without incrementing the importance variable X.

In Block 323, it is determined whether a redundant asset is available. The redundant asset is an equivalent to the equipment in the functional area, e.g., to replace the asset when the asset fails. If the determination is positive, i.e., a redundant asset is available, the algorithm increments the importance variable X before proceeding to Block 324. If the determination is negative, i.e., no redundant asset is available, the algorithm proceeds directly to Block 324 without incrementing the importance variable X.

In Block 324, it is determined whether output reserve (e.g., a buffer or product tank) of the asset is available. The output reserve is a pre-determined amount of asset output, e.g., stored in the buffer or product tank to sustain customer delivery when the asset fails. If the determination is positive, i.e., an output reserve of the asset is available, the algorithm increments the importance variable X before proceeding to Block 326. If the determination is negative, i.e., no output reserve of the asset is available, the algorithm proceeds directly to Block 326 without incrementing the importance variable X. In Block 326, the asset importance score B is set to equal to the importance variable X.

Turning to FIG. 3D, FIG. 3D illustrates an algorithm for determining the asset reliability and maintainability score of a functional location. In Block 330, it is determined whether the asset is mothballed and or if the asset has a spare (i.e., a component or equipment for repair or replacement) in the warehouse. If the determination is positive for either case, i.e., the asset is mothballed or has a spare in the warehouse, the algorithm assigns a value 4 to a mean-time-to-repair (MTTR) variable before proceeding to Block 334. If the determination is negative for both cases, i.e., the asset is not mothballed (i.e., in active use) and does not have a spare in the warehouse, the algorithm proceeds to Block 331 to calculate a mean-time-between-failure or mean-time-before-failure (MTBF) variable and evaluate the asset obsolescence and whether the repair location is out-of-country (OOC) in a parallel process. Within Block 331, the variable MTBF is assigned a numerical value ranging from 1 to 4. This value is determined based on the percentile of the asset's MTBF compared to the reference MTBF of similar or equivalent assets operating in the same or equivalent process unit within the plant or industry peers. The reference MTBF can be obtained from the company's AMS (150), CMMS (190), or recognized international industry reliability and maintainability databanks, and the algorithm proceeds to Block 335. For example, if a gas compressor is not being mothballed and does not have a warehouse spare bundle, its MTBF is 15 years, while the reference MTBF for similar gas compressors in the industry peers is 20 years. In this case, the MTBF for that particular gas compressor falls within the range of 70-95% of the industry average. Consequently, it would receive an MTBF score of 3. In addition, in Block 331, it is determined whether the asset is obsolete and if the asset requires OOC repair before proceeding to Block 333. If the outcome of Block 331 is affirmative, i.e., the asset is considered obsolete, the algorithm sets the MTTR variable to 0, and then proceeds to Block 333a. If the outcome is negative, depending on whether the OOC repair is required or not, the MTTR variable is assigned a numerical value within the range of [0-4]. This assignment is determined by referring to the lookup tables (in Block 333b and Block 333c), and whether the repair is conducted out-of-country (OOC) (Block 333b) or in-country (IC) (Block 333c). This value is determined based on the percentile of the asset's MTTR compared to the reference MTTR of similar or equivalent assets operating in the same or equivalent process unit within the plant or industry peers. The reference MTTR can be obtained from the company's (AMS) (150), CMMS (190), or recognized international industry reliability and maintainability databanks. For example, if a gas turbine is not obsolete and requires OOC repair, with an MTTR of 12 months while the reference MTTR for similar gas turbines in the industry peers is 3 months, then the MTTR for that specific gas turbine exceeds 300% of the industry average. As a result, it would receive a MTTR score of 0. In an alternative example, if a gas compressor is not considered obsolete and does not necessitate OOC repair, its MTTR is 5 weeks, while the reference MTTR for similar gas compressors in the industry peers is 2 weeks. In this case, the MTTR for that particular gas compressor falls within the range of 200-300% of the industry average. Consequently, it would receive an MTTR score of 1. Once the MTTR variable is assigned the numerical value according to either one of the look up tables, the algorithm proceeds to Block 335 where the asset reliability and maintenance score (denoted as C) is assigned the smaller value of the MTBF variable and the MTTR variable.

FIG. 3E illustrates an algorithm for determining the asset utilization score of a functional location. In Block 340, it is determined whether the asset is mothballed and or if the asset has intermittent duty, where intermittent duty refers, for example, to an equipment that is used no more than once in 3 months, for a duration not exceeding 2 weeks of continuous operation. If the determination is positive for either case, i.e., the asset is mothballed or has intermittent duty, the algorithm proceeds to Block 343a to assign a value 4 to the asset utilization score (denoted as D). If the determination is negative for both cases, i.e., the asset is not mothballed (i.e., in active use) and does not in intermittent duty (i.e., the asset is in active and continuous duty), the algorithm proceeds to Block 341 to calculate total actual production rate of the functional location by aggregating the actual production rate of each asset over all assets of the functional location. The sensors in the plant information (PI) system or AMS allow to accurately measure the actual production rate for each asset. The equipment function location capacity utilization rate is determined by comparing the total actual production rate for the equipment function location to its design production rate. It measures how effectively the equipment function location is being utilized. The function location's total design rate is calculated by aggregating the production rates of each individual asset operating under the same function location and in parallel. This provides a comprehensive understanding of the expected production capacity for the entire function location. The individual asset design production rate can be extracted from the asset smart datasheet, AMS or CMMS. Once the equipment function location is established, we proceed to Block 343 and the asset utilization score is assigned in Block 343c a numerical value in the range of [0-4] based on the utilization rate according to a first look up table (Block 343b).

As an example, the criteria for assigning the numerical values [0-4] to the failure consequences score, the asset importance score, the asset reliability and maintainability score, and the asset utilization score are listed in TABLE 1 below. In TABLE 1, a contingency plan refers to any plan available to operations to alleviate the stringent constraints on production other than the buffer/product tank(s). Reference means similar or equivalent asset operating in the same or equivalent process unit in industry peers. In case the MTBF and MTTR for an asset fall within different Asset Reliability & Maintainability Categories, the lowest score is assigned to the PECA Asset Reliability & Maintainability criterion. For example, if an asset has a MTBF that is 60% of MTBF Reference and a MTTR that is 130% of the MTTR Reference; hence, falling in the scores 2 and 3 on the Asset Rel. & Maintainability Category, an Asset Reliability & Maintainability score of 2 is assigned to be on the conservative side.

Based on the algorithms described above, an Asset Criticality Index (ACI) is calculated as follows:

ACI=(asset failure consequences score)×(asset importance score)×(asset reliability and maintainability score)×(asset utilization score)

As each of the failure consequences score, the asset importance score, the asset reliability and maintainability score, and the asset utilization score has a numerical value ranging from zero (0) indicating high criticality to four (4) indicating low criticality, the ACI has a numerical value ranging from zero (0) indicating high asset production criticality to two hundred fifty-six “256” indicating the lowest asset production criticality. Based on the ACI numerical values, the asset production criticality is classified into three (3) classes listed in TABLE 2 below.

TABLE 1

| | | ASSETCR [symbol] SCORING GUIDELINES MATRIX | | |
|---|---|---|---|---|
| | | 0 | 1 | 2 |
| ASSET | [symbol] | VERY HIGH (SIGNIFICANT/ | HIGH (MAJOR) | MEDIUM (MODERATE) |
| | | CATASTROPHIC) | As per the company's | As per the company's |
| | | As per the company's approved | approved safety | approved safety management |
| | | safety management guidelines | management guidelines | guidelines (SMG) for asset |
| | | (SMG) for asset failure | (SMG) for asset failure | failure consequences |
| | | consequences evaluation and | consequences evaluation | evaluation and scoring |
| | | scoring | and scoring | |
| | [symbol] | STRATEGIC | IMPORTANT | PRIMARY |
| | | NONE OF THE ALTERNATIVES | ATLEAST ONE (1) | ATLEAST TWO (2) OF THE |
| | | LISTED BELOW ARE AVAILABLE | OF THE ALTERNATIVES | ALTERNATIVES LISTED BELOW |
| | | TO OPERATIONS TO ALLEVIATE | LISTED BELOW IS | ARE AVAILABLE TO OPERATIONS |
| | | THE STRINGENT CONSTRAINTS | AVAILABLE TO OPERATIONS | TO ALLEVIATE THE STRINGENT |
| | | ON PRODUCTION | TO ALLEVIATE THE STRINGENT | CONSTRAINTS ON PRODUCTION |
| | | A CONTINGENCY | CONSTRAINTS ON PRODUCTION | A CONTINGENCY PLAN AVAILABLE |
| | | PLAN AVALABLE TO ALLEVIATE | A CONTINGENCY PLAN | TO ALLEVIATE THE ASSET FAILURE |
| | | THE ASSET FAILURE (NOTE1). | AVAILABLE TO ALLEVIATE | (NOTE1). |
| | | A REDUNDANT ASSET | THE ASSET FAILURE (NOTE 1). | A REDUNDANT ASSET IS AVAILABLE. |
| | | IS AVAILABLE. | A REDUNDANT ASSET IS AVAILABLE. | A BUFFER PRODUCT TANK IS |
| | | A BUFFER PRODUCT | A BUFFER PRODUCT TANK | AVAILABLE. |
| | | TANK IS AVAILABLE | IS AVAILABLE. | |
| | [symbol] | VERY LOW RELIABILITY | LOW RELIABILITY AND | MEDIUM RELIABLITY AND |
| | | AND/OR VERY DIFFICULT | DIFFICULT MAINTAINABILITY | MAINTAINABILITY |
| | | MAINTAINABILITY | THE ASSET IS TO | THE ASSET HAS A MODERATE |
| | | THE ASSET IS NOT A SECONDARY | BE REFURBISHED | RELIABILITY (M [symbol] ) AND |
| | | OR A BACK-UP ASSET AND | OR OVERHAULED AND | MAINTAINABILITY (MTTR) RECORDS |
| | | IT IS OBSOLETE WITH NO SPARE | IT HAS A POOR RELIABILITY | AS OUTLINED BELOW |
| | | PARTS AVAILABLE IN THE | (M [symbol] ) AND MAINTAINABILITY | 0.50% < MTBF ACHIEVED <=70% |
| | | MARKET, OR | (M [symbol] ) RECORDS AS OUTLINED | OF MT [symbol] REFERENCE (1) |
| | | THE ASSET REQUIRES [symbol] | BELOW 0 MTBF ACHIEVED <= [symbol] | 0 [symbol] < MTTR ACHIEVED <=200% |
| | | REPAIR, WITH EXTENSIVE | OF M [symbol] REFERENCE (1) | OF MTBF |
| | | REPAIR DURATION INCLUDING | 0 MTTR ACHIEVED > [symbol] | REFERENCE(1) |
| | | LOGISTICS, WITH [symbol] ≥ [symbol] | OF MTTR REFERENCE (1) | |
| | | OF THE [symbol] RE [symbol] (1). | | |
| | [symbol] | VERY HIGH | HIGH UTILIZATION (MAJOR) | MEDIUM UTILIZATION (MODERATE) |
| | | UTILIZATION | ASSET CAPACITY UTILIZATION IS | ASSET CAPACITY UTILIZATION IS |
| | | (SATURATED) | HIGH AND THERE IS POSSIBLITY | MEDIUM AND THERE IS POSSIBILTY |
| | | ASSET | TO COMPENSATE FOR MINOR | TO COMPENSATE FOR A MODERATE |
| | | UTILIZATION IS SATURATED AND | UNPLANNED DOWNTIME BY | UNPLANNED DOWNTIME BY |
| | | THERE IS NO POSSIBILITY TO | INCREASING THE UTILIZATION OF | INCREASING THE UTILIZATION |
| | | COMPENSATE FOR ANY UNPLANNED | THE AVAILABLE CAPACITY | OF THE AVAILABLE CAPACITY. |
| | | DOWNTIME. | UTILIZATION RATE >90% | 80% < UTILIZATION RATE ≤ [symbol] |
| | | UTILIZATION RATE\hat{ } 100% | | |

| | | ASSETCR [symbol] SCORING GUIDELINES MATRIX | |
|---|---|---|---|
| | | 3 | 4 |
| ASSET | [symbol] | LOW (MINOR) | VERY LOW (INSIGNIFICANT) |
| | | As per the company's approved | As per the company's approved |
| | | safety management guidelines | safety management guidelines |
| | | (SMG) for asset failure | (SMG) for asset failure |
| | | consequences evaluation and | consequences evaluation and |
| | | scoring | scoring |
| | [symbol] | ORDINARY | SECONDARY |
| | | ALL THE THREE (3) ALTERNATIVES | IF THE ASSET FUNCTION |
| | | LISTED BELOW ARE AVAILABLE TO | CONFIGURATION |
| | | OPERATIONS TO ALLEVIATE THE | IS DIFFERENT FROM THREE ASSET |
| | | STRINGENT CONSTRAINTS ON PRODUCTION | IMPORTANCE CATEGORIES LISTED |
| | | A CONTINGENCY PLAN AVAILABLE | IN THIS TABLE (E.G. MOTHBALLED) |
| | | TO ALLEVIATE THE ASSET FAILURE | ASSETS OFFLINE SPARED ASSET |
| | | (NOTE1). | IN THE WAREHOUSE, ETC.)(NOTE2). |
| | | A REDUNDANT ASSET IS AVAILABLE | |
| | | A BUFFER PRODUCT TANK | |
| | | IS AVAILABLE. | |
| | [symbol] | HIGH RELIABILITY AND LOW | VERY HIGH RELIABILITY AND |
| | | MAINTAINABILITY | VERY LOW MAINTAINABILITY |
| | | THE ASSET IS IN GOOD CONDITION | THE ASSET IS NEW OR HAS |
| | | WITH GOOD RELIABILITY (MTBF) | EXCELLENT RELIABILITY (MTBF) |
| | | AND MAINTAINABILITY (MTTR) | AND MAINTAINABILITY (MTTR) |
| | | RECORDS AS OUTLINED BELOW | RECORDS AS OUTLINED BELOW |
| | | 0.70% < MT [symbol] ACHIEVED <= [symbol] | 0 MTBF ACHIEVED ≥95% OF |
| | | OF [symbol] REFERENCE (1) | MTBF REFERENCE (1) |
| | | 0 [symbol] < MTTR ACHEIVED <= [symbol] | 0 MTTR ACHIEVED <=120% OF |
| | | OF MTBF REFERENCE (1) | MTBF REFERENCE (1) |
| | [symbol] | LOW UTILIZATION (MINOR) | VERY LOW UTILIZATION |
| | | ASSET CAPACITY UTILIZATION IS | (INSIGNIFICANT) |
| | | LOW AND THERE IS POSSIBILITY | ASSET CAPACITY UTILIZATION |
| | | TO COMPENSATE FOR A LARGE | IS VERY LOW AND WE CAN |
| | | UNPLANNED DOWNTIME BY | COMPENSATE FOR ANY UNPLANNED |
| | | INCREASING THE UTILIZATION | DOWNTIME BY INCREASING THE |
| | | OF THE AVAILABLE CAPACITY. | UTILIZATION OF THE AVAILABLE |
| | | [symbol] 0% < UTILIZATION RATE ≤ 80% | CAPACITY. |
| | | | UTILIZATION RATE ≤ [symbol] |

[symbol]

indicates data missing or illegible when filed

TABLE 2

| Asset | | |
|---|---|---|
| Criticality | Asset Criticality | Asset Production |
| Class | Index (ACI) | Criticality |
| Class A | 00 ≤ ACI ≤ 002 | Production Critical |
| | | Asset |
| Class B | 03 ≤ ACI ≤ 024 | Production Important |
| | | Asset |
| Class C | 25 ≤ ACI ≤ 256 | Production Ordinary |
| | | Asset |

FIG. 3G illustrates an example of performing a preventive maintenance operation or a corrective maintenance operation for the production important category or production ordinary category. As shown in FIG. 3G, the preventive maintenance strategy (380) includes planned maintenance/inspection (381) and periodic maintenance/inspection (382). Each of the planned maintenance/inspection (381) and periodic maintenance/inspection (382) entails condition-based maintenance/inspection, parts replacement, overhaul, refurbishment, modification, corrosion management, and remaining life estimate of the deployed equipment. Further as shown in FIG. 3G, the corrective maintenance strategy (385) includes run-to-life (RTF) maintenance (386) and unplanned maintenance (387). The RTF maintenance (386) entails basic safety & integrity maintenance/inspection tasks, temporary-fix, repair, overhaul, refurbishment, replacement/modification, root cause analysis (RCA), failure reporting/analysis/corrective action (FRACA), and management of change (MoC). The unplanned maintenance (387) entails failure/trip/leak inspection, repair/overhaul, failure diagnosis, root cause analysis (RCA), failure reporting/analysis/corrective action (FRACA), and management of change (MoC).

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand- alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method to perform an equipment maintenance operation of a facility, comprising:
obtaining, from an Asset Management Solution (AMS) or a Computerized Maintenance Management System (CMMS), a hierarchical equipment list of the facility;
identifying, from the hierarchical equipment list, a plurality of functional locations of the facility, wherein each of the plurality of functional locations comprises a plurality of pieces of equipment, wherein each of the plurality of pieces of equipment is assigned a plurality of equipment attributes in the AMS or CMMS;
retrieving, from the AMS or CMMS, the plurality of equipment attributes of all equipment deployed in the plurality of functional locations;
analyzing the plurality of equipment attributes of all equipment deployed in the plurality of functional locations to generate a failure consequences score, an importance score, a reliability and maintainability score, and a utilization score of each of the plurality of functional locations; and
facilitating, based on the failure consequences score, the importance score, the reliability and maintainability score, and the utilization score of each of the plurality of functional locations, the equipment maintenance operation of the facility.

2. The method of claim 1, further comprising:
calculating, based on the failure consequences score, the importance score, the reliability and maintainability score, and the utilization score of said each of the plurality of functional locations, a criticality index of said each of the plurality of functional locations; and
generating a maintenance priority ranking of the plurality of functional locations based on respective criticality indices,
wherein the equipment maintenance operation of the facility is performed according to the maintenance priority ranking.

3. The method of claim 2, further comprising:
categorizing, based on the criticality index, said each of the plurality of functional locations into one of a production critical category, a production important category, and a production ordinary category,
wherein the equipment maintenance operation comprises a prescriptive maintenance operation for the production critical category, a preventive maintenance operation for the production important category, and a corrective maintenance operation for the production ordinary category.

4. The method of claim 1, wherein generating the failure consequences score comprises:
determining, based on the plurality of equipment attributes, a measure of human risk, a measure of environmental risk, a measure of economic risk, and a measure of reputation risk that correspond to an equipment failure event at said each of the plurality of functional locations; and
aggregating, using a pre-determined algorithm, the measure of human risk, the measure of environmental risk, the measure of economic risk, and the measure of reputation risk to calculate the failure consequences score of said each of the plurality of functional locations.

5. The method of claim 1, wherein generating the importance score comprises:
determining, based on the plurality of equipment attributes, a measure of warehouse spare availability, a measure of contingency plan availability, a measure of redundant equipment availability, and a measure of equipment output buffer availability that correspond to an equipment failure event at said each of the plurality of functional locations; and
aggregating, using a pre-determined algorithm, the measure of warehouse spare availability, the measure of contingency plan availability, the measure of redundant equipment availability, and the measure of equipment output buffer availability to calculate the importance score of said each of the plurality of functional locations.

6. The method of claim 1, wherein generating the reliability and maintainability score comprises:
determining, based on the plurality of equipment attributes, a measure of mean-time-before-failure and a measure of mean-time-to-repair that correspond to an equipment failure event at said each of the plurality of functional locations; and
aggregating, using a pre-determined algorithm, the measure of mean-time-before-failure and the measure of mean-time-to-repair to calculate the reliability and maintainability score of said each of the plurality of functional locations.

7. The method of claim 1, wherein generating the utilization score comprises:
determining, based on the plurality of equipment attributes, a measure of equipment capacity and a measure of equipment utilization that correspond to said each of the plurality of functional locations; and
aggregating, using a pre-determined algorithm, the measure of equipment capacity and the measure of equipment utilization to calculate the utilization score of said each of the plurality of functional locations.

8. A Process Equipment Criticality Assessment (PECA) engine for an equipment maintenance operation of a facility, comprising:
a computer processor; and
memory storing instructions, when executed by the computer processor comprising functionality for:
obtaining, from an Asset Management Solution (AMS) or a Computerized Maintenance Management System (CMMS), a hierarchical equipment list of the facility;
identifying, from the hierarchical equipment list, a plurality of functional locations of the facility, wherein each of the plurality of functional locations comprises a plurality of pieces of equipment, wherein each of the plurality of pieces of equipment is assigned a plurality of equipment attributes in the AMS or CMMS;
retrieving, from the AMS or CMMS, the plurality of equipment attributes of all equipment deployed in the plurality of functional locations;
analyzing the plurality of equipment attributes of all equipment deployed in the plurality of functional locations to generate a failure consequences score, an importance score, a reliability and maintainability score, and a utilization score of each of the plurality of functional locations; and
facilitating, based on the failure consequences score, the importance score, the reliability and maintainability score, and the utilization score of each of the plurality of functional locations, the equipment maintenance operation of the facility.

9. The PECA engine of claim 8, the instructions, when executed by the computer processor further comprising functionality for:
calculating, based on the failure consequences score, the importance score, the reliability and maintainability score, and the utilization score of said each of the plurality of functional locations, a criticality index of said each of the plurality of functional locations; and
generating a maintenance priority ranking of the plurality of functional locations based on respective criticality indices,
wherein the equipment maintenance operation of the facility is performed according to the maintenance priority ranking.

10. The PECA engine of claim 9, the instructions, when executed by the computer processor further comprising functionality for:
categorizing, based on the criticality index, said each of the plurality of functional locations into one of a production critical category, a production important category, and a production ordinary category,
wherein the equipment maintenance operation comprises a prescriptive maintenance operation for the production critical category, a preventive maintenance operation for the production important category, and a corrective maintenance operation for the production ordinary category.

11. The PECA engine of claim 8, wherein generating the failure consequences score comprises:
determining, based on the plurality of equipment attributes, a measure of human risk, a measure of environmental risk, a measure of economic risk, and a measure of reputation risk that correspond to an equipment failure event at said each of the plurality of functional locations; and
aggregating, using a pre-determined algorithm, the measure of human risk, the measure of environmental risk, the measure of economic risk, and the measure of reputation risk to calculate the failure consequences score of said each of the plurality of functional locations.

12. The PECA engine of claim 8, wherein generating the importance score comprises:
determining, based on the plurality of equipment attributes, a measure of warehouse spare availability, a measure of contingency plan availability, a measure of redundant equipment availability, and a measure of equipment output buffer availability that correspond to an equipment failure event at said each of the plurality of functional locations; and
aggregating, using a pre-determined algorithm, the measure of warehouse spare availability, the measure of contingency plan availability, the measure of redundant equipment availability, and the measure of equipment output buffer availability to calculate the importance score of said each of the plurality of functional locations.

13. The PECA engine of claim 8, wherein generating the reliability and maintainability score comprises:
determining, based on the plurality of equipment attributes, a measure of mean-time-before-failure and a measure of mean-time-to-repair that correspond to an equipment failure event at said each of the plurality of functional locations; and
aggregating, using a pre-determined algorithm, the measure of mean-time-before-failure and the measure of mean-time-to-repair to calculate the reliability and maintainability score of said each of the plurality of functional locations.

14. The PECA engine of claim 8, wherein generating the utilization score comprises:
determining, based on the plurality of equipment attributes, a measure of equipment capacity and a measure of equipment utilization that correspond to said each of the plurality of functional locations; and
aggregating, using a pre-determined algorithm, the measure of equipment capacity and the measure of equipment utilization to calculate the utilization score of said each of the plurality of functional locations.

15. A facility comprising:
a plurality of functional locations, wherein each of the plurality of functional locations comprises a plurality of pieces of equipment;
an Asset Management Solution (AMS) for managing an equipment performance and maintenance operation of the facility;
a Computerized Maintenance Management System (CMMS) for performing an equipment maintenance operation of the facility, wherein each of the plurality of pieces of equipment is assigned a plurality of equipment attributes in the CMMS; and
a Process Equipment Criticality Assessment (PECA) engine comprising functionality for:
obtaining, from the AMS or CMMS, a hierarchical equipment list of the facility;
identifying, from the hierarchical equipment list, the plurality of functional locations;
retrieving, from the AMS or CMMS, the plurality of equipment attributes of all equipment deployed in the plurality of functional locations;
analyzing the plurality of equipment attributes of all equipment deployed in the plurality of functional locations to generate a failure consequences score, an importance score, a reliability and maintainability score, and a utilization score of each of the plurality of functional locations; and
facilitating, based on the failure consequences score, the importance score, the reliability and maintainability score, and the utilization score of each of the plurality of functional locations, the equipment maintenance operation of the facility.

16. The facility of claim 15, the PECA engine further comprising functionality for:
calculating, based on the failure consequences score, the importance score, the reliability and maintainability score, and the utilization score of said each of the plurality of functional locations, a criticality index of said each of the plurality of functional locations;
generating a maintenance priority ranking of the plurality of functional locations based on respective criticality indices, wherein the equipment maintenance operation of the facility is performed according to the maintenance priority ranking; and
categorizing, based on the criticality index, said each of the plurality of functional locations into one of a production critical category, a production important category, and a production ordinary category, wherein the equipment maintenance operation comprises a prescriptive maintenance operation for the production critical category, a preventive maintenance operation for the production important category, and a corrective maintenance operation for the production ordinary category.

17. The facility of claim 15, wherein generating the failure consequences score comprises:
determining, based on the plurality of equipment attributes, a measure of human risk, a measure of environmental risk, a measure of economic risk, and a measure of reputation risk that correspond to an equipment failure event at said each of the plurality of functional locations; and
aggregating, using a pre-determined algorithm, the measure of human risk, the measure of environmental risk, the measure of economic risk, and the measure of reputation risk to calculate the failure consequences score of said each of the plurality of functional locations.

18. The facility of claim 15, wherein generating the importance score comprises:
determining, based on the plurality of equipment attributes, a measure of warehouse spare availability, a measure of contingency plan availability, a measure of redundant equipment availability, and a measure of equipment output buffer availability that correspond to an equipment failure event at said each of the plurality of functional locations; and
aggregating, using a pre-determined algorithm, the measure of warehouse spare availability, the measure of contingency plan availability, the measure of redundant equipment availability, and the measure of equipment output buffer availability to calculate the importance score of said each of the plurality of functional locations.

19. The facility of claim 15, wherein generating the reliability and maintainability score comprises:
determining, based on the plurality of equipment attributes, a measure of mean-time-before-failure and a measure of mean-time-to-repair that correspond to an equipment failure event at said each of the plurality of functional locations; and
aggregating, using a pre-determined algorithm, the measure of mean-time-before-failure and the measure of mean-time-to-repair to calculate the reliability and maintainability score of said each of the plurality of functional locations.

20. The facility of claim 15, wherein generating the utilization score comprises:
determining, based on the plurality of equipment attributes, a measure of equipment capacity and a measure of equipment utilization that correspond to said each of the plurality of functional locations; and
aggregating, using a pre-determined algorithm, the measure of equipment capacity and the measure of equipment utilization to calculate the utilization score of said each of the plurality of functional locations.
